(19) United States
(12) Patent Application Publication
(10) Pub. No.: US 2003/0076312 A1
(43) Pub. Date: Apr. 24, 2003

(54) Image display control for a plurality of images

(76) Inventor: Kenji Yokoyama, Kanagawa (JP)

Correspondence Address: MORGAN & FINNEGAN, L.L.P., 345 PARK AVENUE, NEW YORK, NY, 10154, US

(21) Appl. No.: 10/277,361

(22) Filed: Oct. 22, 2002

(30) Foreign Application Priority Data
Oct. 23, 2001 (JP) 325295/2001(PAT.)

(51) Int. Cl. G09G 5/00

(52) U.S. Cl. 345/204

(57) ABSTRACT

Sensed image data are stored in a memory. Image data of a plurality of images associated with each other out of the stored image data are detected on the basis of a predetermined condition. The image data of the plurality of detected images are processed into image data of a predetermined display size. The same portion of the processed image data is extracted from each of the plurality of images. The extracted portions of the image data of the plurality of images are displayed on the same screen.

### FIELD OF THE INVENTION

The present invention relates to an image display apparatus and image display control method capable of displaying, as monitor images, image data of a plurality of images sensed by an image sensor, a recording medium, and a program.

### BACKGROUND OF THE INVENTION

There have conventionally been proposed image display apparatuses which sense an optical image incident via a lens by an image sensor such as a CCD, temporarily store the sensed image in a memory, read out image data from the memory after sensing, and display the data on a monitor, and digital cameras having such image display apparatuses.

Some of the conventional image display apparatuses have a multi-image display function of reducing the image of-each frame into a predetermined image size, laying out the reduced images in a predetermined pattern, and displaying a predetermined number of images on one screen. As an apparatus having the multi-image display function, Japanese Patent Laid-Open No. 11-231410 discloses a camera which allows confirming the exposure level of an object to be sensed and the degree of defocus.

Japanese Patent No. 3073363 discloses a multi-image display system which has a multi-image display memory and can enlarge/move the window. Japanese Patent Laid-Open No. 2000-125185 discloses a camera which displays images sensed by auto exposure bracketing (AEB) operation on the same screen in the order of exposure so as to easily compare the images on the LCD, and which allows selecting an image/images to be erased.

Auto exposure bracketing image sensing operation is an image sensing technique of sensing images while changing exposures (exposure shift). For example, an object is sensed on the first frame of a film at proper exposure Tv and Av values (results of exposure calculation at that time), on the second frame at Tv and Av values corresponding to overexposure by one step, and on the third frame at Tv and Av values corresponding to underexposure by one step. This exposure shift image sensing operation is automatically performed by a camera. The same scene is successively sensed while the exposure is automatically changed. A photograph (image) sensed at an exposure suited to the photographer's purpose can be selected from a plurality of photographs (images) after the sensing operation.

In the multi-image display function of a conventional image display apparatus, the multi-image display form (the number of display images, reduction size, or the like) is determined in advance in accordance with a monitoring screen size. For displaying images sensed by auto exposure bracketing image sensing operation, the images of three to five frames must be displayed on the same screen. With the size reduction of the display area due to a recent current of minimizing the size of a camera, the image size of each frame decreases as the number of successively sensed images of the same scene (confirmation images) by auto exposure bracketing image sensing operation, multiple image sensing operation, or the like increases.

FIGS. 19A and 19B are views showing a conventional confirmation images sensed in the auto exposure bracketing (AEB) mode. FIG. 19A shows an image displayed with a size conforming to the monitor display area, and assumes that a person to be sensed is at the center. In the AEB mode, the object is sensed while the exposure of the object image in FIG. 19A is changed. AEB confirmation images are displayed, as shown in FIG. 19B, and those are an image sensed at an exposure determined to be proper (±0), an image sensed at an overexposure by one step (+1F), and an image sensed at an underexposure by one step (−1F) in AEB image sensing.

Images in FIG. 19B are reproduced from the same image data as index images. To display a plurality of images in accordance with the monitor size, obtained pixel data are thinned to reproduce images. Images are displayed for confirming the exposure after image sensing, but the displayed images are poor in visibility. Thus, the displayed images are not satisfactory as comparison images to be viewed side by side in order to compare detailed difference between the images due to different exposures.

### SUMMARY OF THE INVENTION

The present invention has been made in consideration of the above situation, and has as its object to provide an image display apparatus capable of displaying easy-to-see multiple images in accordance with the size of a display monitor by utilizing obtained image data as much as possible for confirmation images of the same scene.

According to the present invention, the foregoing object is attained by providing an image display apparatus comprising: a memory adapted to store sensed image data; a detection unit adapted to detect image data of a plurality of images associated with each other on the basis of a predetermined condition out of the image data stored in the memory; a processing unit adapted to process the image data of the plurality of images detected by the detection unit into image data of a predetermined display size; an extraction unit adapted to extract same portions of the image data of the plurality of images processed by the processing unit; and a display unit adapted to display the portions of the image data of the plurality of images extracted by the extraction unit on the same screen.

According to the present invention, the foregoing object is also attained by providing an image display control method comprising the steps of: detecting image data of a plurality of images associated with each other, on the basis of a predetermined condition, out of image data stored in a memory adapted to store sensed image data; processing the image data of the plurality of detected images into image data of a predetermined display size; extracting same portions of the processed image data of the plurality of images; and displaying the portions of the image data of the plurality of extracted images on the same screen.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of an image display apparatus according to a first embodiment of the present invention;

FIG. 2 is a flow chart showing a sequence before image sensing according to the first embodiment of the present invention;

FIG. 3 is a flow chart showing image display operation in image sensing according to the first embodiment of the present invention;

FIG. 4 is a flow chart showing distance measurement/photometry processing according to the first embodiment of the present invention;

FIG. 5 is a flow chart showing image sensing operation according to the first embodiment of the present invention;

FIG. 6 is a flow chart showing image recording operation according to the first embodiment of the present invention;

FIGS. 7A and 7B are views showing an example of an image monitor panel;

FIG. 8 is a flow chart showing the flow of image confirmation processing according to the first embodiment of the present invention;

FIG. 9 is a view showing an example of an index display;

FIGS. 10A and 10B are views showing an example of an image layout for image confirmation according to the first embodiment of the present invention;

FIGS. 11A and 11B are views showing a display example of a confirmation image when the central region is extracted in an image confirmation sequence according to the first embodiment of the present invention;

FIG. 12 is a flow chart showing the flow of image confirmation processing according to a second embodiment of the present invention;

FIGS. 13A and 13B are views showing an example of the image layout for image confirmation according to the second embodiment of the present invention;

FIGS. 14A and 14B are views showing a display example of the confirmation image when the longitudinal central portion is extracted in the image confirmation sequence according to the second embodiment of the present invention;

FIGS. 15A and 15B are views showing an example of the image layout for image confirmation according to a modification of the second embodiment of the present invention;

FIGS. 16A and 16B are views showing a display example of the confirmation image when the lateral portion is extracted in the image confirmation sequence according to the modification of the second embodiment of the present invention;

FIG. 17 is a flow chart showing the flow of image confirmation processing according to a third embodiment of the present invention;

FIGS. 18A and 18B are views showing an example of the image layout for image confirmation according to the third embodiment of the present invention; and

FIGS. 19A and 19B are views showing a conventional display example of confirmation images sensed in a AEB mode.

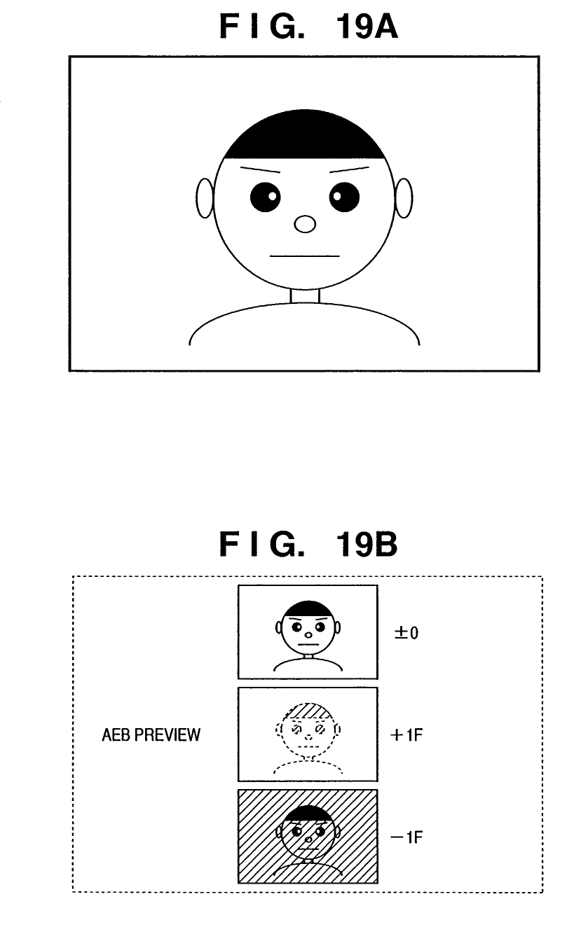

### DETAILED DESCRIPTION OF THE PREFERRED EMBODIMENTS

Preferred embodiments of the present invention will be described in accordance with the accompanying drawings.

<First Embodiment>

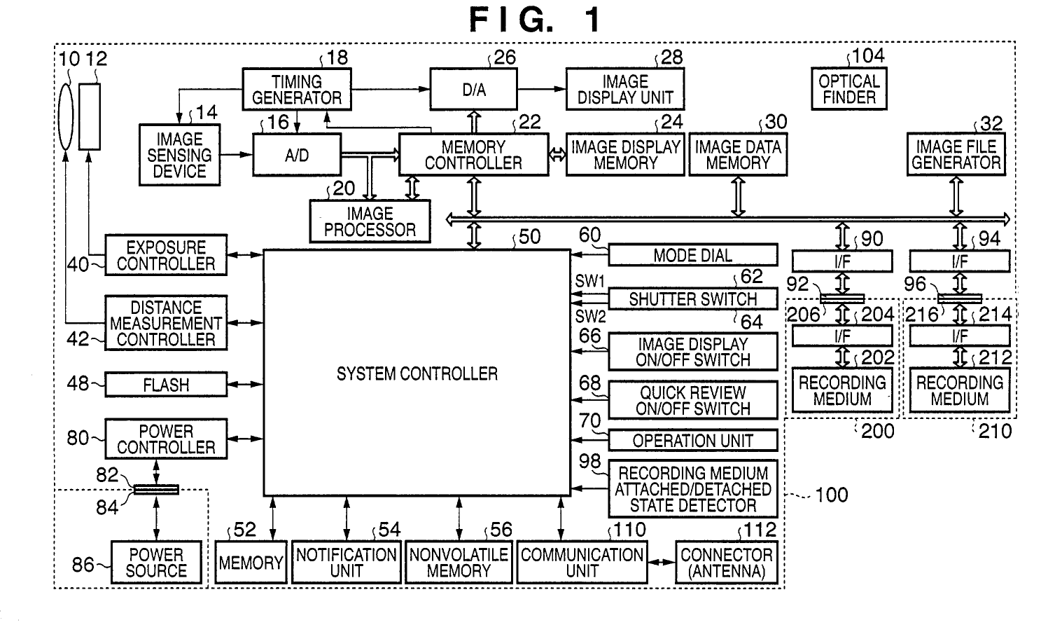

FIG. 1 is a block diagram showing the configuration of an image display apparatus according to the first embodiment of the present invention. In FIG. 1, reference numeral 100 denotes a camera having an image processing apparatus; 10, an image sensing lens; 12, a shutter having a diaphragm function; 14, an image sensing device such as a CCD which converts an optical image into an electric signal; and 16, an A/D converter which converts an analog signal output from the image sensing device 14 into a digital signal.

Numeral 18 denotes a timing generator which supplies a clock signal and a control signal to the image sensing device 14, the A/D converter 16, and a D/A converter 26, under the control of a memory controller 22 and a system controller 50.

Numeral 20 denotes an image processor which performs predetermined pixel interpolation processing and color conversion processing on data from the A/D converter 16 or data from the memory controller 22. The image processor 20 performs predetermined calculation processing using the sensed image data, and the system controller 50 performs TTL (Through-The-Lens) AF (Auto Focus) processing, AE (Auto Exposure) processing, and EF (Electronic Flash) processing with respect to an exposure controller 40 and a distance measurement controller 42, based on the result of calculations. Exposure control for exposure shift according to the first embodiment is executed in accordance with a program stored in the system controller 50.

Further, the image processor 20 performs predetermined calculation processing using the sensed image data, and performs TTL AWB (Auto White Balance) processing, based on the result of calculations. The memory controller 22 controls the A/D converter 16, the timing generator 18, the image processor 20, an image display memory 24, the D/A converter 26, an image data memory 30, and an image file generator 32.

Data from the A/D converter 16 is written into the image display memory 24 or the image data memory 30 via the image processor 20 and the memory controller 22, or only via the memory controller 22. Numeral 28 denotes an image display unit comprising a TFT LCD or the like. Display image data written in the image display memory 24 is displayed on the image display unit 28 via the D/A converter 26.

The image display unit 28 is arranged on the rear surface of the camera, and displays a confirmation image after image sensing and various information notifications by communication with the system controller 50. By sequentially displaying sensed image data using the image display unit 28, an image monitor with an electronic finder function can also be implemented.

The memory 30, used for storing obtained still images and moving images, has a sufficient storage capacity for storing a predetermined number of still images and a moving image for a predetermined period. In sequential image sensing to sequentially obtain a plural number of still images or panoramic image sensing, a large amount of image data can be written into the image data memory 30 at a high speed. Further, the image data memory 30 can be used as a work area for the system controller 50.

The image file generator 32 compresses or expands image data into a file. The image file generator 32 reads images stored in the image data memory 30, performs compression or expansion processing, and writes the processed data into the image data memory 30. The image file generator 32 converts R, G, and B image data stored in the image data memory 30 into YC data made from a luminance signal Y and color difference signals C, and generates an image file obtained by compressing the YC data by JPEG (Joint Photographic coding Experts Groups).

More specifically, 9-MB image data from the image data memory 30 is compressed into data of about 2.25 MB by YC transform, DCT (Discrete Cosine Transform), ADCT (Adjust Discrete Cosine Transform), or the like, and encoded with a Huffman code or the like into a data file of about 230 kB.

Compressed data written in the image data memory 30 is read out, and the image is output as a thumbnail image to the image display unit 28. Data are successively read out, displayed side by side on the image display unit 28, and can be monitored as index images (multiple images).

The exposure controller 40 controls the shutter 12 having the diaphragm function. The exposure controller 40 interlocked with a flash 48 also has a flash adjusting function. The distance measurement controller 42 controls focusing of the image sensing lens 10. The distance measurement controller 42 measures a distance from a distance measurement point selected from a plurality of distance measurement points, and drives the lens. The flash 48 has an AF auxiliary light projection function and a flash adjusting function.

The exposure controller 40 and the distance measurement controller 42 are controlled by the TTL method. The system controller 50 controls the exposure controller 40 and the distance measurement controller 42, in accordance with the result of calculations of sensed image data by the image processor 20. The system controller 50 controls the overall image display apparatus 100, and is a microcomputer which incorporates a ROM, a RAM, an A/D converter, and a D/A converter. Numeral 52 denotes an external memory which stores the constants, variables, and programs for the operation of the system controller 50.

Numeral 54 denotes a notification unit such as a liquid crystal display device or loudspeaker which notifies operating statuses, messages, and the like by using characters, images, sound, and the like, in correspondence with execution of a program by the system controller 50. Especially, the display device or devices is/are provided in a single or plural easy-to-see positions near the operation unit 70 of the image display apparatus 100, and comprises/comprise, e.g., a combination of an LCD, an LED, and a sound generating device. Further, some of the functions of the notification unit 54 are provided within an optical finder 104.

The display contents of the notification unit 54, displayed on the LCD or the like, include indication of single shot/sequential image sensing, a self timer, a compression rate, the number of recording pixels, the number of recorded images, the number of recordable images, a shutter speed, an f number (aperture), exposure compensation, flash illumination, pink-eye effect mitigation, macro image sensing, a buzzer-set state, a timer battery level, a battery level, an error state, information of plural digit numbers, attached/detached status of recording media 200 and 210, operation of communication I/F, and date and time. The notification unit 54 also displays AEB image sensing settings and multiple image sensing settings.

Some pieces of information out of the display contents of the notification unit 54 can also be displayed on the image display unit 28. The display contents of the notification unit 54, displayed within the optical finder 104, include a focus state, a camera shake warning, a flash charge state, the shutter speed, the f number (aperture), and the exposure compensation. Numeral 56 denotes an electrically erasable and recordable nonvolatile memory such as an EEPROM.

Numerals 60, 62, 64, 66, 68, and 70 denote operation units for inputting various operation instructions to the system controller 50. These operation units comprise a single or plurality of combinations of switches, dials, touch panels, a device for pointing by line-of-sight detection, a voice recognition device, and the like.

The mode dial switch 60 can be switched between various function modes such as a power OFF mode, an automatic image sensing mode, an image sensing mode, a panoramic image sensing mode, a reproduction mode, a multi-image reproduction/deletion mode, and a PC connection mode. The AEB mode and the multiple mode according to the present invention are also set by this mode dial switch.

Reference numeral 62 is a shutter switch SW1 turned ON by half stroke of a shutter button (not shown), to instruct start of the operations of the AF processing, the AE processing, the AWB processing, the EF processing, and the like. Reference numeral 64 is a shutter switch SW2 turned ON by full stroke of the shutter button (not shown), to instruct start of a series of operations of exposure processing to write a signal read from the image sensing device 14 into the image data memory 30, via the A/D converter 16 and the memory controller 22, image sensing processing by using calculations by the image processor 20 and the memory controller 22, and recording processing to read the image data from the image data memory 30, compress the image data by the image file generator 32, and write the image data into the recording medium 200 or 210.

Reference numeral 66 is an image display ON/OFF switch which can set ON/OFF of the image display unit 28. Reference numeral 68 is a quick review ON/OFF switch which can set the quick review function of automatically reproducing sensed image data immediately after image sensing. This switch can also switch the display arrangement of multiple images.

The operation unit 70 comprises various buttons and touch panels including a menu button, a set button, a macro button, a multi-image reproduction/repaging button, a flash set button, a single-shot/sequential/self-timer image sensing selection button, a forward (+) menu item selection button, a backward (−) menu item selection button, a forward (+) reproduction image search button, a backward (−) reproduction image search button, an image sensing quality selection button, an exposure correction button, and a date/time set button.

Numeral 80 denotes a power controller comprising a battery detection circuit, a DC-DC converter, a switch circuit to select the block to be energized, and the like. The power controller 80 detects the attached/detached state of the battery, the battery type, and the remaining battery power level, controls the DC-DC converter based on the results of detection and an instruction from the system controller 50, and supplies a necessary voltage to the respective units including the recording medium for the necessary period.

Numerals 82 and 84 denote power connectors; 86, a power source comprising a primary battery such as an alkaline battery or a lithium battery, a secondary battery such as an NiCd battery, an NiMH battery, or an Li battery, an AC adapter, and the like; 90 and 94, interfaces for recording media such as a memory card or a hard disk; 92 and 96, connectors for connection with the recording media such as a memory card or a hard disk; and 98, a recording medium attached/detached state detector which detects whether the recording medium 200 and/or 210 is attached to the connector 92 and/or connector 96.

In the present embodiment, two systems of interfaces and connectors for connection with the recording media are employed. However, the number of systems is not limited, and a single or plurality of interfaces and connectors for connection with the recording media may be provided. Further, interfaces and connectors pursuant to different standards may be combined. As the interfaces and connectors, cards in conformity with standards such as a PCMCIA card and a CF (Compact Flash (R)) card which are external recording media may be used.

In a case where cards and connectors in conformity with the PCMCIA card standards, CF card standards, and the like are used as the interfaces 90 and 94 and the connectors 92 and 96, image data and management information attached to the image data can be transmitted/received to/from other peripheral devices such as a computer and a printer by connection with various communication cards such as a LAN card, a modem card, a USB card, an IEEE 1394 card, a P1284 card, an SCSI card, and a PHS communication card.

The optical finder 104 can be used for image sensing without using the image monitoring function of the image display unit 28. In the optical finder 104, realized are some of the functions of the notification unit 54 including the indication of focus state, the camera shake warning, the flash charge state, the shutter speed, the f number (aperture), the exposure compensation, and the like.

Numeral 110 denotes a communication unit having various communication functions including RS 232C, USB, IEEE 1394, P1284, SCSI, modem, LAN, and radio communication functions; and 112, a connector for connecting the image display apparatus 100 to another device via the communication unit 110 or an antenna for radio communication. The recording medium 200 comprises a memory card, a hard disk, or the like.

The recording medium 200 has a recording unit 202 of a semiconductor memory, a magnetic disk, or the like, an interface 204 with the image display apparatus 100, and a connector 206 for connection with the image display apparatus 100. Also, the recording medium 210 comprises a memory card, a hard disk, or the like, and has a recording unit 212 of a semiconductor memory, a magnetic disk, or the like, an interface 214 with the image display apparatus 100, and a connector 216 for connection with the image display apparatus 100.

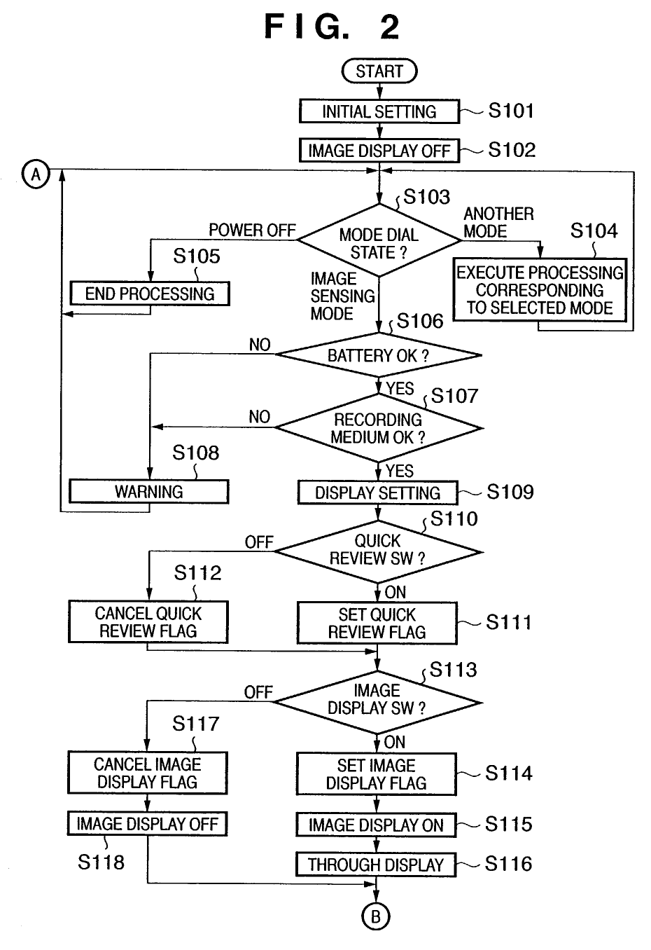

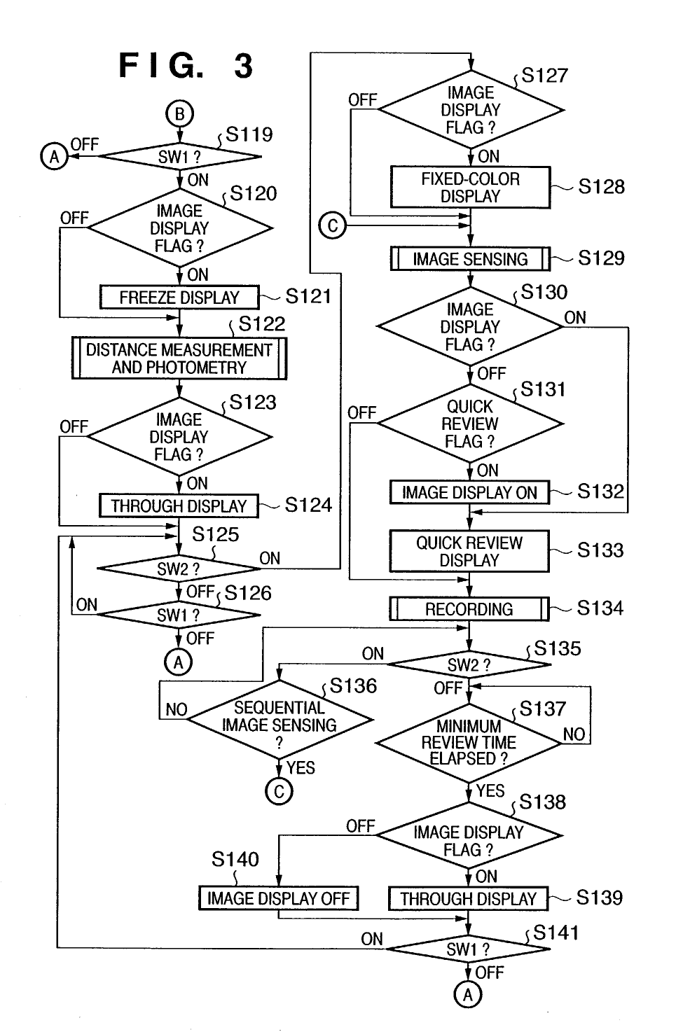

The basic sequence and image sensing sequence of a series of operations in the first embodiment will be described with reference to the flow charts of FIGS. 2, 3, 4, 5, and 6. FIGS. 2 and 3 show the flow charts of the main routine of the image display apparatus 100 according to the first embodiment. First, the operation of the image display apparatus 100 will be explained with reference to FIGS. 2 and 3.

In FIG. 2, the system controller 50 initializes flags, control variables, and the like upon power ON such as battery exchange (step S101), and initializes the image display of the image display unit 28 to the OFF state (step S102). The system controller 50 checks the set position of the mode dial 60 (step S103). If the mode dial 60 is set in power OFF, the system controller 50 changes the display of each display unit to an end state (step S105). The system controller 50 records necessary parameters, set values, and set modes including flags and control variables in the nonvolatile memory 56. The power controller 80 performs predetermined end processing to stop providing unnecessary power to the respective units of the image display apparatus 100 including the image display unit 28. Then, the flow returns to step S103.

If the mode dial 60 is set in the image sensing mode (step S103), the flow advances to step S106. If a multiple mode of successively sensing the same scene, such as an AEB mode of sensing the same scene a plurality of number of times at different exposure values or a sequential image sensing mode is selected in step S103 in the image sensing mode, the system controller 50 records the set mode in the memory 56.

If the mode dial switch 60 is set in another mode (step S103), the system controller 50 executes processing corresponding to the selected mode (step S104). After processing ends, the flow returns to step S103. An example of another mode in step S104 includes an image confirmation mode (to be described later) where an index image is displayed for confirming sensed images or an obtained image is corrected, processed, and filed.

The system controller 50 checks using the power controller 80 whether the remaining amount or operation state of the power source 86 formed from a battery or the like poses a trouble in the operation of the image display apparatus 100 (step S106). If the power source 86 has a trouble, the system controller 50 notifies a predetermined warning by an image or sound using the notification unit 54 (step S108), and then the flow returns to step S103.

If the power source 86 is free from any trouble (YES in step S106), the system controller 50 checks whether the operation state of the recording medium 200 or 210 poses a trouble in the operation of the image display apparatus 100, especially in image data recording/reproduction operation with respect to the recording medium 200 or 210 has a trouble (step S107). If a trouble is detected, the system controller 50 notifies a predetermined warning by an image or sound using the notification unit 54 (step S108), and then the flow returns to step S103.

If the operation state of the recording medium 200 or 210 is free from any trouble (YES in step S107), the system controller 50 notifies a user of various set states of the image display apparatus 100 by images or sound using the notification unit 54 (step S109). If the image display of the image display unit 28 is ON, the system controller 50 notifies various set states of the image display apparatus 100 by images also using the image display unit 28.

The system controller 50 checks the set state of the quick review ON/OFF switch 68 (step S110). If the quick review is set ON, the system controller 50 sets the quick review flag (step S111); if the quick review is set OFF, cancels the quick review flag (step S112). The state of the quick review flag is stored in the internal memory of the system controller 50 or the memory 52.

The system controller 50 checks the set state of the image display ON/OFF switch 66 (step S113). If the image display is set ON, the system controller 50 sets the image display flag (step S114), sets the image display of the image display unit 28 to the ON state (step S115), and sets a through display state in which sensed image data are sequentially displayed (step S116). After that, the flow advances to step S119 in FIG. 3.

In the through display state, the image monitoring function is realized by sequentially displaying, on the image display unit 28 via the memory controller 22 and the D/A converter 26, data obtained by the image sensing device 14 and sequentially written in the image display memory 24 via the A/D converter 16, the image processor 20, and the memory controller 22.

If the image display ON/OFF switch 66 is set OFF (step S113), the system controller 50 cancels the image display flag (step S117), sets the image display of the image display unit 28 to the OFF state (step S118), and advances to step S119.

In image display OFF, image sensing is performed using the optical finder 104 without using the image monitoring function of the image display unit 28. In this case, the power consumption of the image display unit 28 which consumes a large amount of power, the D/A converter 26, and the like can be reduced. The state of the image display flag is stored in the internal memory of the system controller 50 or the memory 52.

The flow advances to processing shown in FIG. 3, and if the shutter switch SW1 is not pressed (step S119), returns to step S103. If the shutter switch SW1 is pressed (step S119), the system controller 50 checks the state of the image display flag stored in the internal memory of the system controller 50 or the memory 52 (step S120). If the image display flag has been set, the system controller 50 sets the display state of the image display unit 28 to a freeze display state (step S121), and advances to step S122.

In the freeze display state, the system controller 50 inhibits rewriting of image data in the image display memory 24 via the image sensing device 14, the A/D converter 16, the image processor 20, and the memory controller 22. Then the system controller 50 displays the image data last written to the image display memory 24 on the image display unit 28 via the memory controller 22 and the D/A converter 26, thereby displaying the frozen image on the image monitor panel.

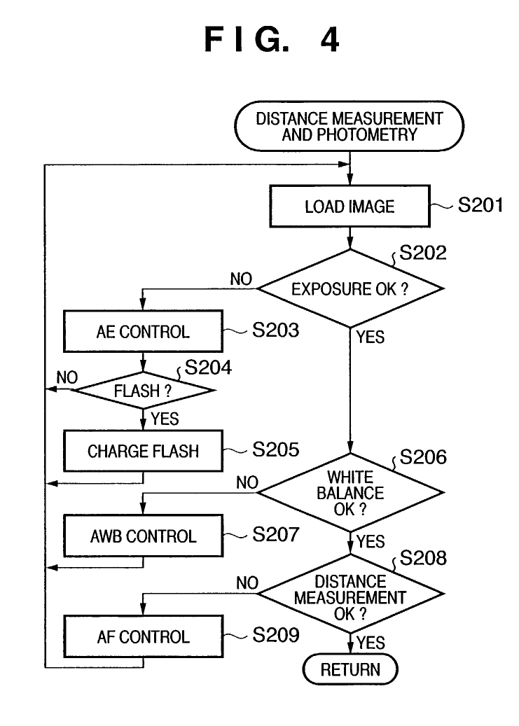

If the image display flag has been canceled (step S120), the system controller 50 directly advances to step S122. The system controller 50 performs distance measurement processing, focuses the image sensing lens 10 on an object to be sensed, performs photometry processing, and determines an f number and a shutter speed (step S122). If necessary, the flash is also set in photometry processing. Details of distance measurement/photometry processing in step S122 will be described with reference to FIG. 4.

After distance measurement/photometry processing (step S122) ends, the system controller 50 checks the state of the image display flag stored in the internal memory of the system controller 50 or the memory 52 (step S123). If the image display flag has been set, the system controller 50 sets the display state of the image display unit 28 to the through display state (step S124), and the flow advances to step S125. The through display state in step S124 is the same operation state as the through state in step S116.

If the shutter switch SW2 is not pressed (step S125) and the shutter switch SW1 is turned off (step S126), the flow returns to step S103. If the shutter switch SW2 is pressed (step S125), the system controller 50 checks the state of the image display flag stored in the internal memory of the system controller 50 or the memory 52 (step S127). If the image display flag has been set, the system controller 50 sets the display state of the image display unit 28 to a fixed-color display state (step S128), and advances to step S129.

In the fixed-color display state, a fixed-color image is displayed on the image monitor panel by displaying fixed-color image data on the image display unit 28 via the memory controller 22 and the D/A converter 26 instead of sensed image data written in the image display memory 24 via the image sensing device 14, the A/D converter 16, the image processor 20, and the memory controller 22.

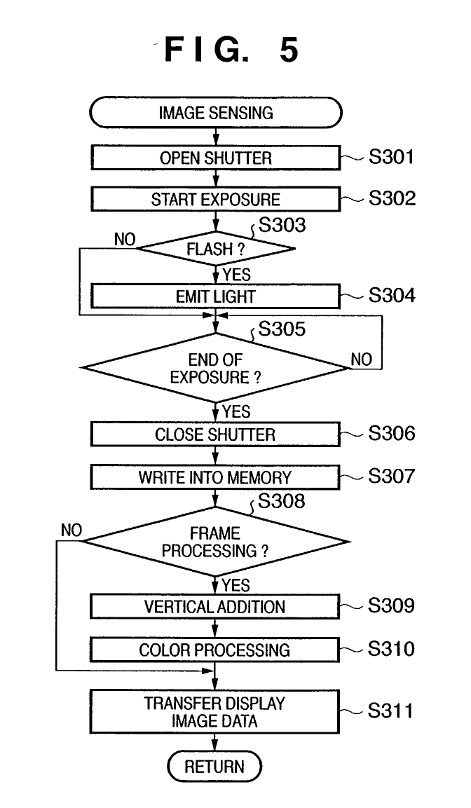

If the image display flag has been canceled (step S127), the flow directly advances to step S129. The system controller 50 executes image sensing processing including exposure processing to write sensed image data into the image data memory 30 via the image sensing device 14, the A/D converter 16, the image processor 20, and the memory controller 22, or via the memory controller 22 directly from the A/D converter 16, and development processing to read out image data written in the image data memory 30 by using the memory controller 22 and, if necessary, the image processor 20 and perform various processes (step S129). Details of image sensing processing in step S129 will be described with reference to FIG. 5.

In step S130, the system controller 50 checks the state of the image display flag stored in the internal memory of the system controller 50 or the memory 52. If the image display flag has been set, quick review display is performed (step S133). In this case, the image display unit 28 keeps displaying an image as an image monitor even during image sensing processing, and quick review display is performed immediately after image sensing processing.

If the image display flag has been canceled (step S130), the system controller 50 checks the state of the quick review flag stored in the internal memory of the system controller 50 or the memory 52 (step S131). If the quick review flag has been set, the system controller 50 sets the image display of the image display unit 28 to the ON state (step S132), and performs quick review display (step S133).

If the image display flag has been canceled (step S130) and the quick review flag has also been canceled (step s131), the flow advances to step S134 with the “OFF” image display unit 28. In this case, the image display unit 28 is kept OFF even after image sensing, and no quick review display is done. This is a utilization way of saving power without using the image monitoring function of the image display unit 28 by eliminating confirmation of a sensed image immediately after image sensing upon sensing images using the optical finder 104.

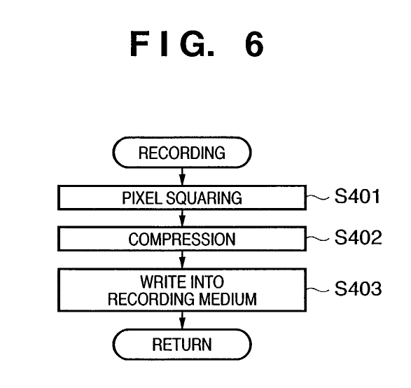

The system controller 50 reads out sensed image data written in the image data memory 30, performs various image processes using the memory controller 22 and if necessary, the image processor 20, and performs image compression processing corresponding to the set mode using the image file generator 32. Thereafter, the system controller 50 executes recording processing to write image data into the recording medium 200 or 210 (step S134). Details of recording processing in step S134 will be described with reference to FIG. 6.

If the shutter switch SW2 is pressed in step S135 at the end of recording processing (step S134), the system controller 50 checks the sequential image sensing flag stored in the internal memory of the system controller 50 or the memory 52 (step S136). If the sequential image sensing flag has been set, the flow returns to step S129 for sequential image sensing, and performs the next image sensing.

To sense only one scene by AEB image sensing, image sensing operation is looped at different exposure values while SW2 is kept pressed in response to the state that the sequential image sensing flag has been set. If the sequential image sensing flag is not set (NO in step S136), the current processing is repeated until the shutter switch SW2 is released (step S135).

If the shutter switch SW2 is released at the end of recording processing (step S134), or if the shutter switch SW2 is released after the shutter switch SW2 is kept pressed to continue the quick review display and confirm a sensed image (step S135), the flow advances to step S138 upon the lapse of a predetermined minimum review time (YES in step S137).

The minimum review time can be set to a fixed value, arbitrarily set by the user, or arbitrarily set or selected by the user within a predetermined range.

If the image display flag has been set (step S138), the system controller 50 sets the display state of the image display unit 28 to the through display state (step S139), and the flow advances to step S141. In this case, after a sensed image is confirmed on the quick review display of the image display unit 28, the image display unit 28 can be set to the through display state in which sensed image data are sequentially displayed for the next image sensing.

If the image display flag has been canceled (step S138), the system controller 50 sets the image display of the image display unit 28 to the OFF state (step S140), and the flow advances to step S141. If the shutter switch SW1 has been pressed (step S141), the flow returns to step S125 and the system controller 50 waits for the next image sensing. If the shutter switch SW1 is released (step S141), the system controller 50 ends a series of image sensing operations and returns to step S103.

FIG. 4 is a flow chart showing details of distance measurement/photometry processing in step S122 of FIG. 3. The system controller 50 reads out charge signals from the image sensing device 14, and sequentially loads sensed image data to the image processor 20 via the A/D converter 16 (step S201). Using the sequentially loaded image data, the image processor 20 performs predetermined calculations used in TTL AE processing, EF processing, and AF processing.

In each processing, a necessary number of specific pixel portions are cut out and extracted from all the pixels, and used for calculations. In TTL AE processing, EF processing, AWB processing, and AF processing, optimal calculations can be achieved for different modes such as a center-weighted mode, an average mode, and an evaluation mode.

With the result of calculations by the image processor 20, the system controller 50 performs AE control using the exposure controller 40 (step S203) until the exposure (AE) is determined to be proper (step S202). With measurement data obtained in AE control, the system controller 50 checks the necessity of the flash (step S204). If the flash is necessary, the system controller 50 sets the flash flag, and charges the flash 48 (step S205).

If the exposure (AE) is determined to be proper (YES in step S202), the system controller 50 stores the measurement data and/or set parameters in the internal memory of the system controller 50 or the memory 52. With the result of calculations by the image processor 20 and the measurement data obtained in AE control, the system controller 50 adjusts the parameters of color processing and performs AWB control using the image processor 20 (step S207) until the white balance (AWB) is determined to be proper (while NO in step S206).

If the white balance (AWB) is determined to be proper (YES in step S206), the system controller 50 stores the measurement data and/or set parameters in the internal memory of the system controller 50 or the memory 52. With the measurement data obtained in AE control and AWB control, the system controller 50 performs distance measurement (AF). Until the result of distance measurement (AF) is determined to exhibit an in-focus state (during NO in step S208), the system controller 50 performs AF control using the distance measurement controller 42 (step S209).

If the distance measurement point is arbitrarily selected from a plurality of distance measurement points, the system controller 50 executes AF control in accordance with the selected point. If the distance measurement point is not arbitrarily selected, it is automatically selected from a plurality of distance measurement points. If the result of distance measurement (AF) is determined to exhibit an in-focus state (YES in step S208), the system controller 50 stores the measurement data and/or set parameters in the internal memory of the system controller 50 or the memory 52, and ends the distance measurement/photometry processing routine (step S122).

FIG. 5 is a flow chart showing details of image sensing processing in step S129 of FIG. 3. The system controller 50 exposes the image sensing device 14 by releasing, by the exposure controller 40, the shutter 12 having the diaphragm function to the f number in accordance with photometry data stored in the internal memory of the system controller 50 or the memory 52 (steps S301 and S302).

The system controller 50 checks based on the flash flag whether the flash 48 is necessary (step S303). If the flash 48 is necessary, the system controller 50 causes the flash to emit light (step S304). The system controller 50 waits for the end of exposure of the image sensing device 14 in accordance with the photometry data (step S305). Then, the system controller 50 closes the shutter 12 (step S306), reads out charge signals from the image sensing device 14, and writes sensed image data into the image data memory 30 via the A/D converter 16, the image processor 20, and the memory controller 22 or directly via the memory controller 22 from the A/D converter 16 (step S307).

If frame processing needs to be performed in accordance with the set image sensing mode (YES in step S308), the system controller 50 reads out image data written in the image data memory 30, by using the memory controller 22 and if necessary, the image processor 20. The system controller 50 sequentially performs vertical addition processing (step S309) and color processing (step S310), and then writes the processed image data into the image data memory 30.

The system controller 50 reads out image data from the image data memory 30, and transfers the image data to the image display memory 24 via the memory controller 22 (step S311). After a series of processes end, the system controller 50 ends the image sensing processing routine (step S129).

FIG. 6 is a flow chart showing details of recording processing in step S134 of FIG. 3. The system controller 50 reads out sensed image data written in the image data memory 30 by using the memory controller 22 and if necessary, the image processor 20. The system controller 50 performs pixel squaring processing to interpolate the pixel aspect ratio of the image sensing device to 1:1 (step S401), and then writes the processed image data into the image data memory 30.

The system controller 50 reads out image data written in the image data memory 30, and performs image compression processing corresponding to the set mode by the image file generator 32 (step S402). The system controller 50 writes the compressed image data into the recording medium 200 or 210 such as a memory card or a compact flash (R) card via the interface 90 or 94 and the connector 92 or 96 (step S403). After write into the recording medium ends, the system controller 50 ends the recording processing routine (step S134).

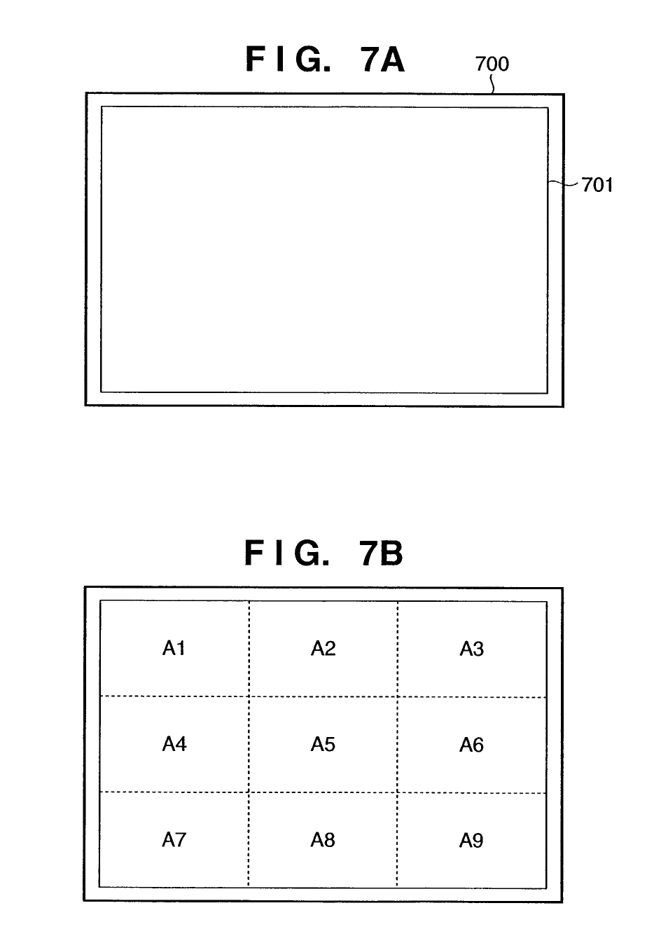

FIGS. 7A and 7B show an example of a region displayed on the image display unit 28. Numeral 701 in FIG. 7A denotes an image region displayed on a monitor panel 700. The maximum image data which is generated from obtained image data by the image file generator 32 so as to conform to the display size (the number of display dots of the monitor) is read out from the image data memory 30 and reproduced. Image data sensed in the above-described manner is read out from each memory and can always be displayed on the image monitor by the system controller 50. Thus, image data can also be reproduced in divided reproduction image data regions, as shown in FIG. 7B.

FIG. 7B shows an example of dividing one image into nine regions, and area data corresponding to any one of divided regions A1 to A9 (referred to, e.g., “area data A1”) can be extracted. In this case, the area data (image data) A5 represents an image portion in the central region.

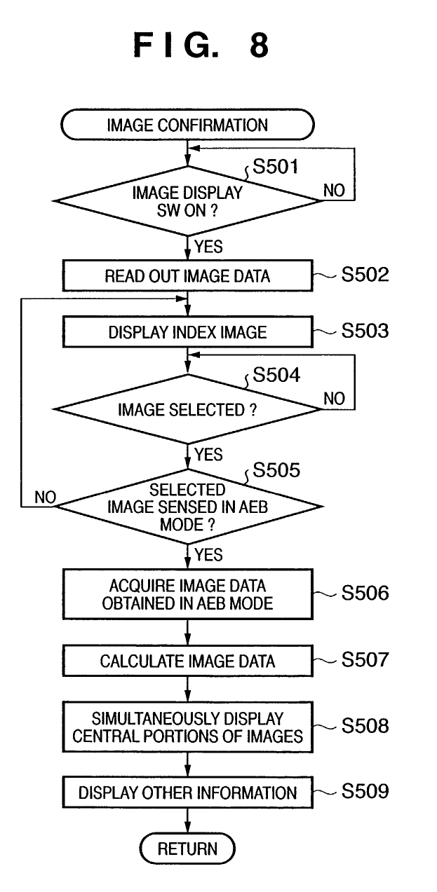

FIG. 8 is a flow chart showing the image confirmation sequence of an AEB-sensed image according to the present invention that is executed as one of processes in step S104 when a mode other than the image sensing mode is set by the mode dial 60 in step S103 of FIG. 2. Whether the image display switch is ON or OFF is checked in order to continue the image confirmation processing of images sensed in the AEB mode (step S501). If the switch is ON, the flow advances to step S502; if OFF, enters the standby state. Recorded image data are read out in response to press of the confirmation switch after image sensing (step S502), and predetermined index images are displayed in accordance with the display monitor size (step S503).

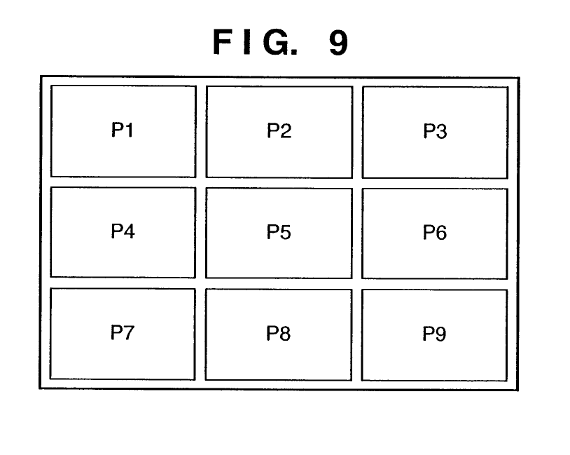

FIG. 9 shows an example of the index image display. Sensed images P1 to P9 are displayed as thumbnail images in nine regions on the monitor panel of the image display unit 28. If one of index images is selected with an image selection switch (reproduction image selection button) included in the operation unit 70 (YES in step S504), the flow advances to step S505, and whether the selected image is an image sensed in the AEB mode is checked by memory collation.

If the image selection switch is not pressed in step S504, the flow enters the standby state. If the selected image is not an image sensed in the AEB mode in step S505, the flow returns to step S503 and enters the standby state while the index images are kept displayed. If an image sensed in the AEB mode is selected in step S505, a plurality of image data sensed at different exposure values in the AEB mode are read out from the memory (step S506). Calculation processing to extract image data representing only the central region of each image data and process the extracted image into image data corresponding to the number of pixels of the monitor panel is executed (step S507).

In this case, to display not only an image but also another information on the monitor, image calculation processing corresponding to the display area is performed. Then, images corresponding to the central region A5 shown in FIG. 7B are rearranged and displayed (step S508). Information such as the exposure data or image number of an image sensed in the AEB mode is displayed on the monitor (step S509), and the confirmation image sequence ends.

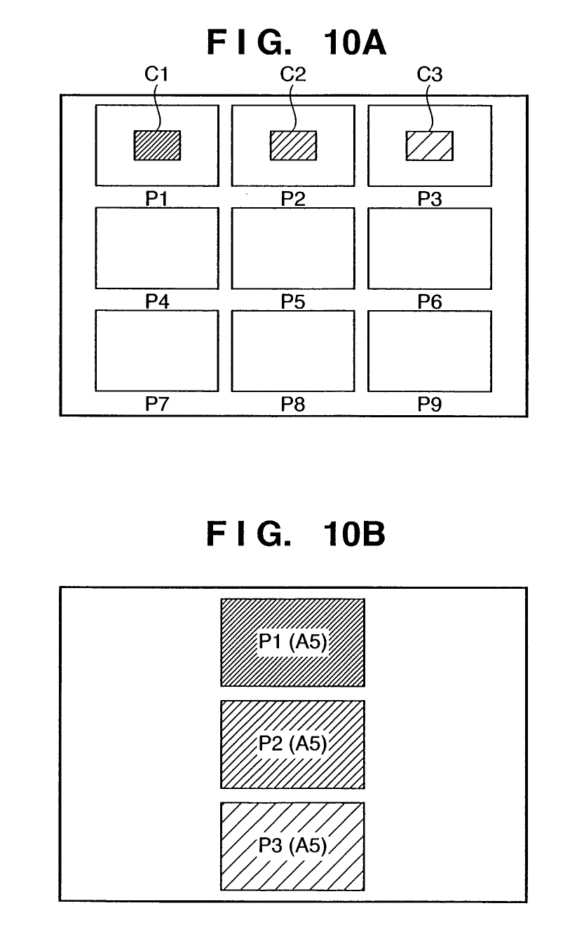

FIGS. 10A and 10B are views showing an example of extracting the central region in the confirmation image sequence. FIG. 10A shows a 9-divided index image display. For example, when the thumbnail images P1, P2, and P3 are images sensed in the AEB mode, C1 to C3 represent the central regions of the thumbnail images P1 to P3.

FIG. 10B shows an example of the AEB confirmation image display. After the thumbnail images P1 to P3 sensed in the AEB mode are selected, the images of the central regions A5 of the corresponding original images (corresponding to the central regions C1 to C3 of the thumbnail images P1 to P3) are displayed. Information such as the state, image data, or image sensing condition data in the AEB mode is displayed in the blank region within the screen.

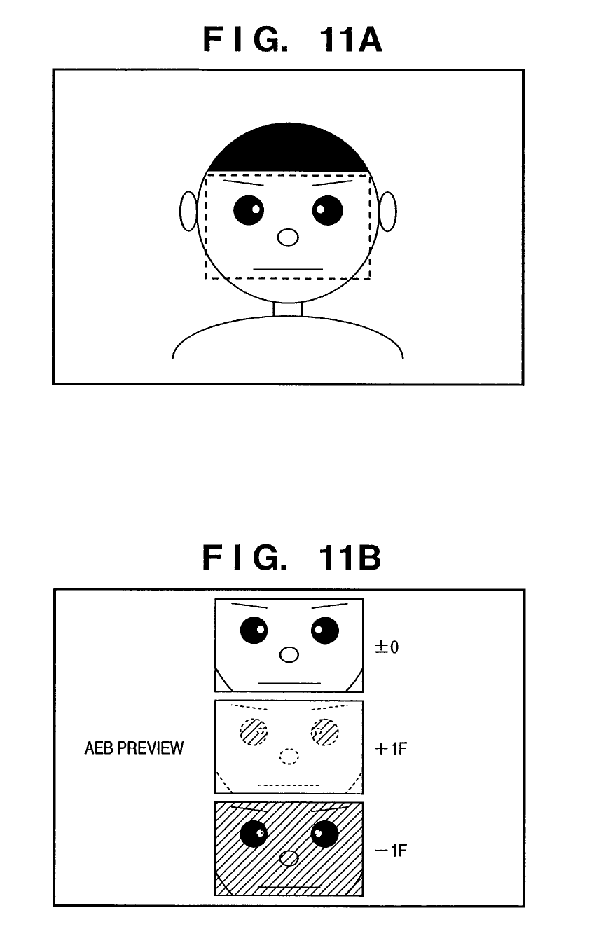

FIGS. 11A and 11B are image views when the central region is extracted in the confirmation image sequence. FIG. 11A shows an image displayed based on image data conforming to the monitor display area that serves as an original image. A person to be sensed is at the center.

A region surrounded by the dashed line in FIG. 11A corresponds to the region A5 shown in FIG. 7B, and image data of the central portion of the face is extracted. FIG. 11B shows the central portions of three images sensed in the AEB mode. These images include an image sensed at an exposure determined to be proper (±0), an image sensed at an overexposure by one step(+1F), and an image sensed at an underexposure by one step (−1F) in AEB image sensing.

In the first embodiment, part (central region) of an image is displayed without using thinned image data for displaying the entire image, unlike the prior art. The image can be reproduced to details of the central region, which facilitates comparison between images of the same scene sensed at different exposure values.

<Second Embodiment>

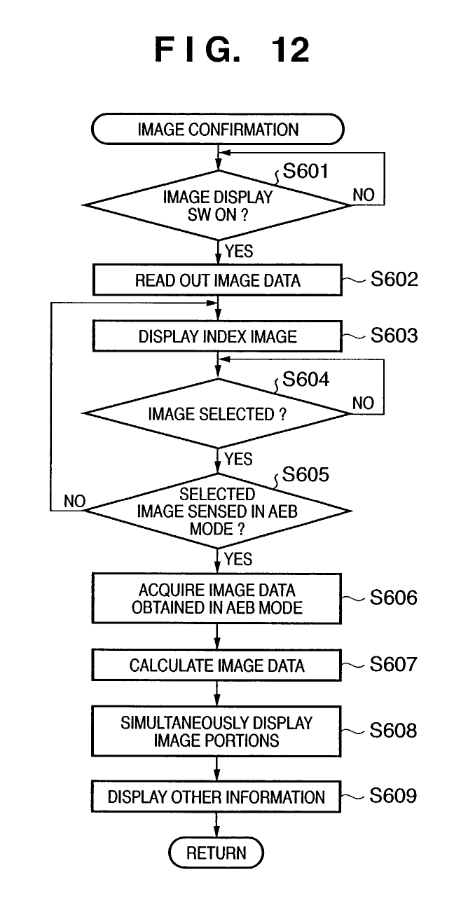

The second embodiment of the present invention will be described on the basis of the configuration described in the first embodiment. FIG. 12 is a flow chart showing another image confirmation sequence of images sensed in the AEB mode according to the second embodiment that is executed as one of processes in step S104 when a mode other than the image sensing mode is set by a mode dial 60 in step S103 of FIG. 2.

Whether the image display switch is ON or OFF is checked in order to continue the image confirmation processing of images sensed in the AEB mode (step S601). If the switch is ON, the flow advances to step S602; if OFF, enters the standby state. Recorded image data are read out in response to press of the confirmation switch after image sensing (step S602), and predetermined index images are displayed in accordance with the display monitor size (step S603).

If one of index images is selected with an image selection switch (reproduction image selection button) included in an operation unit 70 (YES in step S604), the flow advances to step S605, and whether the selected image is an image sensed in the AEB mode is checked by memory collation.

If the image selection switch is not pressed in step S604, the flow enters the standby state. If the selected image is not an image sensed in the AEB mode in step S605, the flow returns to step S603 and enters the standby state while the index images are kept displayed. If an image sensed in the AEB mode is selected in step S605, a plurality of image data sensed at different exposure values in the AEB mode are read out from the memory (step S606). Calculation processing to extract image data representing the central band region of each image data and process the extracted image into image data corresponding to the number of pixels of the monitor panel is executed (step S607).

In this case, to display not only an image but also another information on the monitor, image calculation processing corresponding to the display area is performed. Then, images corresponding to the images of the central band are rearranged and displayed (step S608). Information such as the exposure data or image number of an image sensed in the AEB mode is displayed on the monitor (step S609), and the confirmation image sequence ends.

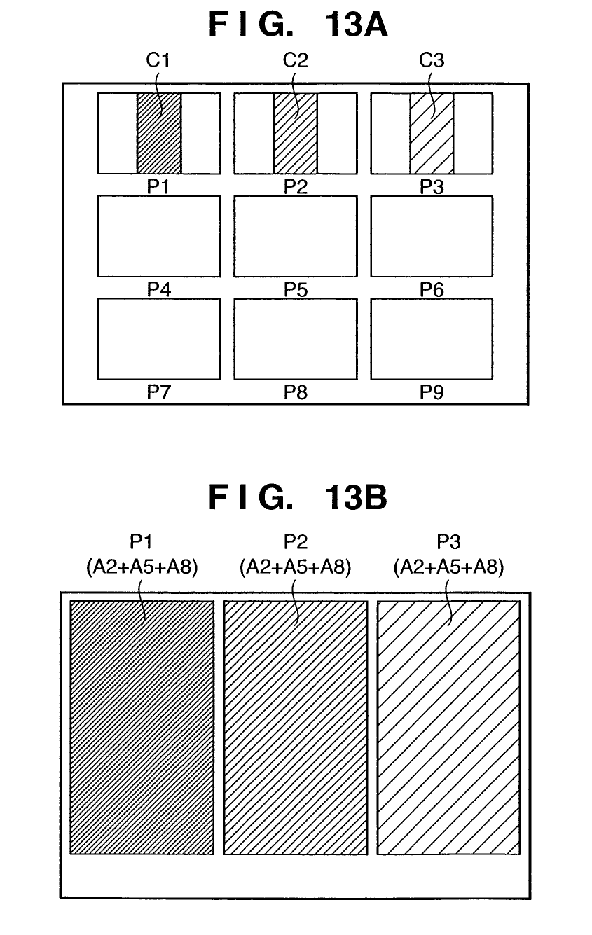

FIGS. 13A and 13B are views showing an example of extracting a longitudinal central band image in the confirmation image sequence. FIG. 13A shows a 9-divided index image display. For example, when the thumbnail images P1, P2, and P3 are images sensed in the AEB mode, C1 to C3 in FIG. 13A represent the longitudinal central band portions of the thumbnail images P1 to P3.

FIG. 13B shows an example of the AEB confirmation image display. After the thumbnail images P1 to P3 sensed in the AEB mode are selected, the images of longitudinal central band portions each of which occupies ⅓ of the corresponding original image (corresponding to the regions A2, A5, and A8 in the example shown in FIG. 7B) are displayed. Information such as the state, image data, or image sensing condition data in the AEB mode is displayed in the blank region within the screen.

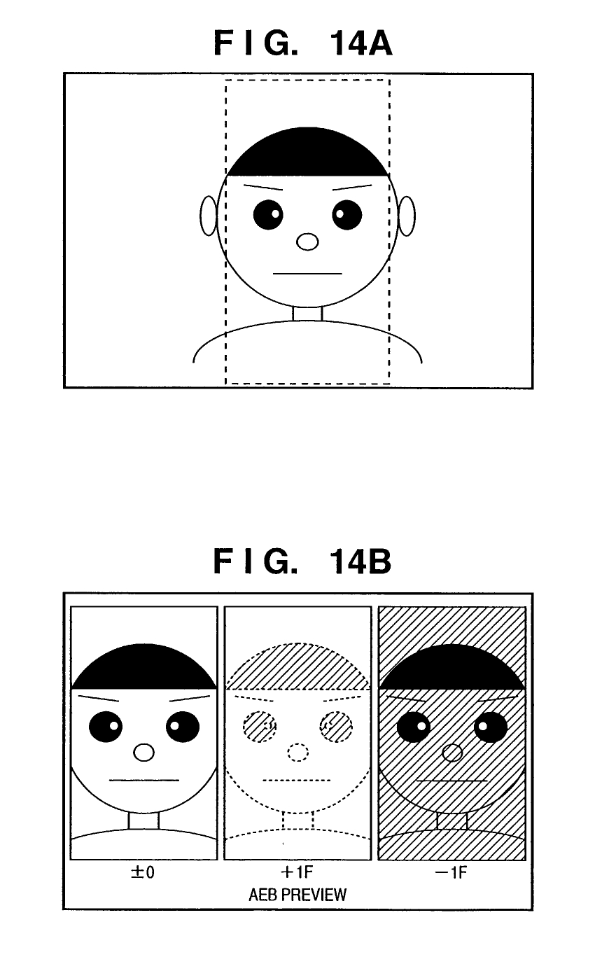

FIGS. 14A and 14B show images displayed when the longitudinal central band portion is extracted in the confirmation image sequence. FIG. 14A shows an image displayed based on image data conforming to the monitor display area that serves as an original image. A person to be sensed is at the center. A region surrounded by the dashed line in FIG. 14A corresponds to the regions A2, A5, and A8 shown in FIG. 7B, and image data of the central portion which occupies ⅓ of the original image is extracted.

FIG. 14B shows the portions of three images sensed in the AEB mode. These images are an image sensed at an exposure determined to be proper (±0), an image sensed at an overexposure by one step(+1F), and an image sensed at an underexposure by one step (−1F) in AEB image sensing.

In the second embodiment, central bands of longitudinally divided portions of a plurality of original images sensed at different exposures as shown in FIGS. 13A and 13B are simultaneously displayed. Therefore, the image portions can be displayed large, images of the same scene can be much easily compared, and the display panel area can be effectively used.

<Modification>

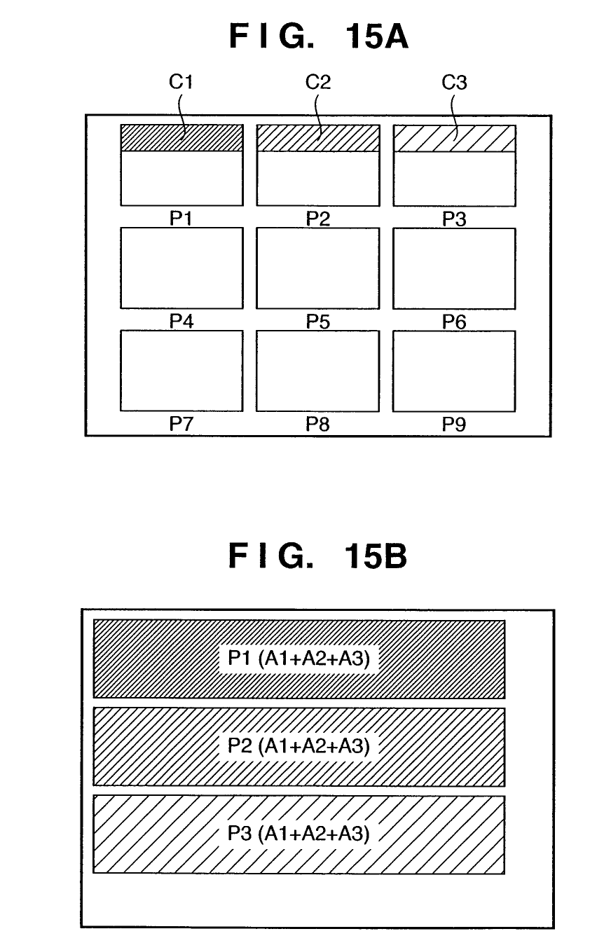

FIGS. 15A and 15B are views showing an example of extracting a lateral partial image in the confirmation image sequence according to a modification of the second embodiment of the present invention. FIG. 15A shows a 9-divided index image display. For example, when the thumbnail images P1, P2, and P3 are images sensed in the AEB mode, C1 to C3 in FIG. 15A represent the lateral band portions of the thumbnail images P1 to P3.

FIG. 15B shows an example of the AEB confirmation image display. After only the thumbnail images P1 to P3 sensed in the AEB mode are selected, the images of lateral band portions each of which occupies ⅓ of the corresponding original image (corresponding to the regions A1, A2, and A3 in the example shown in FIG. 7B) are displayed. Information such as the state, image data, or image sensing condition data in the AEB mode is displayed in the blank region within the screen.

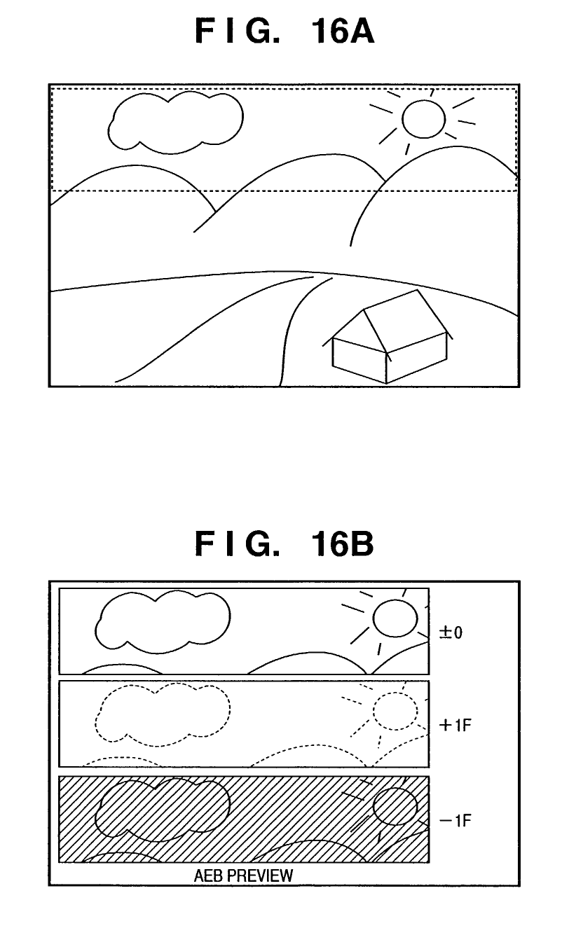

FIGS. 16A and 16B show images displayed when the lateral band portion is extracted in the confirmation image sequence. FIG. 16A shows an image displayed based on image data conforming to the monitor display area that serves as an original image. A landscape is assumed to be sensed. A region surrounded by the dashed line in FIG. 16A corresponds to the regions A1, A2, and A3 shown in FIG. 7B, and image data of the lateral band portion which occupies ⅓ of the original image is extracted.

FIG. 16B shows the portions of three images sensed in the AEB mode. These images are an image sensed at an exposure determined to be proper (±0), an image sensed at an overexposure by one step(+1F), and an image sensed at an underexposure by one step (−1F) in AEB image sensing.

In this way, only portions of a plurality of original images sensed at different exposures are simultaneously displayed, and thus displayed large. Accordingly, images of the same scene can be much easily compared, and the display panel area can be effectively used.

The display portion of an image sensed in the AEB mode is not limited to those (region A5, regions A2, A5, and A8, or regions A1, A2, and A3) described in the first, second embodiments and its modification. An arbitrary region can be selected from the region shown in FIG. 7B as far as the selected region can be displayed on one screen.

<Third Embodiment>

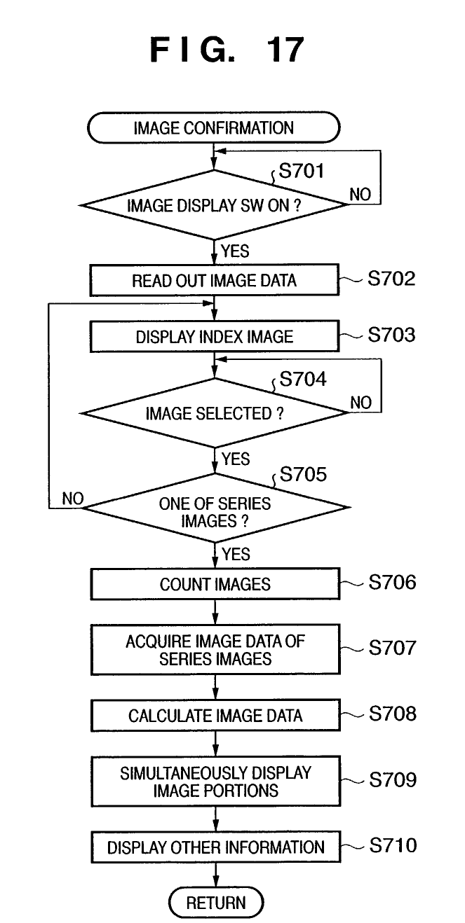

The third embodiment of the present invention will be described on the basis of the configuration described in the first embodiment. FIG. 17 is a flow chart showing still another image confirmation sequence of images sensed in the AEB mode according to the third embodiment that is executed as one of processes in step S104 when a mode other than the image sensing mode is set by a mode dial 60 in step S103 of FIG. 2.

Whether the image display switch is ON or OFF is checked in order to continue the image confirmation processing of images sensed in the AEB mode (step S701). If the switch is ON, the flow advances to step S702; if OFF, enters the standby state. Recorded image data are read out in response to press of the confirmation switch after image sensing (step S702), and predetermined index images are displayed in accordance with the display monitor size (step S703).

If one of index images is selected with an image selection switch (reproduction image selection button) included in an operation unit 70 (YES in step S704), the flow advances to step S705, and the mode is determined by memory collation to determine whether the selected image is a successively sensed image (series scene).

That is, whether the same scene has been sensed in the AEB mode, the multiple image sensing mode, or the like is determined. The mode can be easily determined by storing states of switches or mode flag set in image sensing or by collation with information data.

If the image selection switch is not pressed in step S704, the flow enters the standby state. If the selected image is not one of series scenes in step S705, the flow returns to step S703 and enters the standby state while the index images are kept displayed.

If one of series scenes is selected in step S705, the number of series scenes is counted (step S706), and image data corresponding to the series scenes are read out from the memory (step S707). Calculation processing to extract a portion from each image data and process the extracted image into image data corresponding to the number of pixels of the monitor panel is executed (step S708).

In this case, to display not only an image but also another information on the monitor, image calculation processing corresponding to the display area is performed, and image processing calculation is done in consideration of the number of images of sensed series scenes. Extracted partial images out of the images of the series scenes are rearranged and displayed (step S709). Information such as the exposure data or image numbers of the images of the series scenes is displayed on the monitor (step S710), and the confirmation image sequence ends.

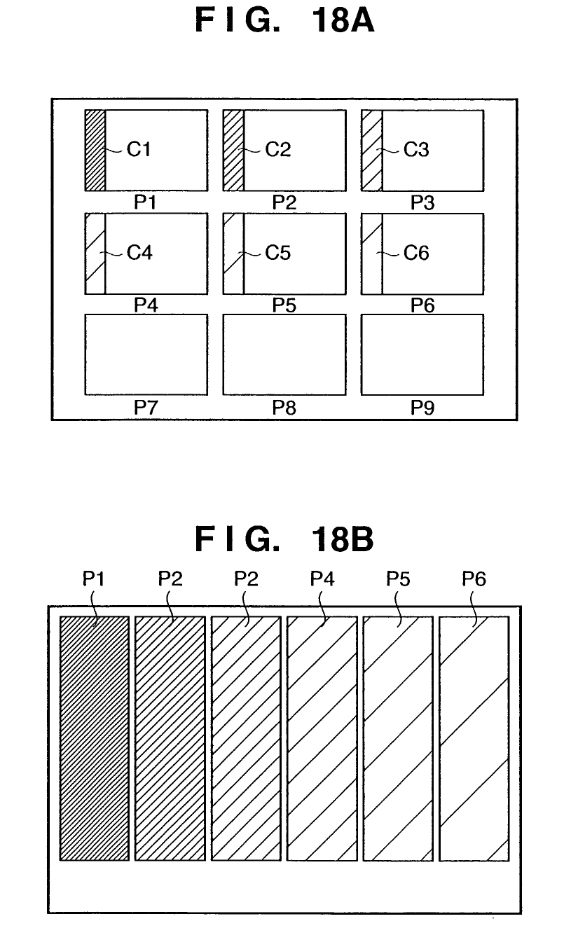

FIGS. 18A and 18B are views showing an example of extracting a partial image from a series scene image in the confirmation image sequence. FIG. 18A shows a 9-divided index image display. For example, when the thumbnail images P1, P2, P3, P4, P5, and P6 are series scene images (original comparison images), C1 to C6 in FIG. 18A represent the longitudinal strip of the thumbnail images P1 to P6.

FIG. 18B shows an example of the series scene image confirmation display. After the series scene images P1 to P6 are selected, image strips each of which occupies 1/n of the corresponding original image (n=the number of series scene images) are displayed. In FIG. 18B, series scenes are made up of the six thumbnail images P1 to P6, and ⅙ of each original image is displayed.

Information such as the state, image data, or image sensing condition data of the series scenes is displayed in the blank region within the screen.

In the third embodiment, the number of images to be compared as shown in FIGS. 18A and 18B is detected, and the images to be compared are displayed in their display areas made to coincide with each other. Thus, portions of the original images can be displayed large, the images can be much easily compared side by side for visual exposure confirmation, and the display panel area can be effectively used.

The above embodiments have exemplified a camera having a monitoring function. The multi-image layout for exposure comparison can also be applied to an image display apparatus which loads, reproduces, and displays a file of sensed image data.

<Other Embodiment>

The present invention can be applied to a system constituted by a plurality of devices (e.g., host computer, display device, interface, camera head) or to an apparatus comprising a single device (e.g., digital camera).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the embodiments, and the storage medium storing the program codes constitutes the invention.

Further, the storage medium, such as a flexible disk, a hard disk, an optical disk, a magneto-optical disk, CD-ROM, CD-R, a magnetic tape, a non-volatile type memory card, and ROM, and computer network, such as LAN (local area network) and WAN, can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to any one of the flowcharts in FIGS. 8, 12, and 17 described in the embodiments.

The present invention is not limited to the above embodiments and various changes and modifications can be made within the spirit and scope of the present invention. Therefore to apprise the public of the scope of the present invention, the following claims are made.

What is claimed is:

1. An image display apparatus comprising:
a memory adapted to store sensed image data;
a detection unit adapted to detect image data of a plurality of images associated with each other on the basis of a predetermined condition out of the image data stored in said memory;
a processing unit adapted to process the image data of the plurality of images detected by said detection unit into image data of a predetermined display size;
an extraction unit adapted to extract same portions of the image data of the plurality of images processed by said processing unit; and
a display unit adapted to display the portions of the image data of the plurality of images extracted by said extraction unit on the same screen.

2. The apparatus according to claim 1, wherein said extraction unit extracts a central region of the image data processed by said processing unit for each image.

3. The apparatus according to claim 1, wherein said extraction unit extracts a predetermined longitudinal divided region of the image data processed by said processing unit for each image.

4. The apparatus according to claim 1, wherein said extraction unit extracts a predetermined lateral divided region of the image data processed by said processing unit for each image.

5. The apparatus according to claim 1 further comprising a selection unit adapted to select a region of the image data to be extracted by said extraction unit,
wherein said extraction unit extracts image data of the region selected by said selection unit.

6. The apparatus according to claim 1, wherein the plurality of associated images include a series of successively sensed images.

7. The apparatus according to claim 1, wherein the plurality of associated images include a series of images sensed successively while changing an exposure.

8. The apparatus according to claim 1, wherein said extraction unit determines an extraction region from each image data processed by said processing unit, in accordance with the number of associated images.

9. An image display control method comprising the steps of:
detecting image data of a plurality of images associated with each other, on the basis of a predetermined condition, out of image data stored in a memory adapted to store sensed image data;
processing the image data of the plurality of detected images into image data of a predetermined display size;
extracting same portions of the processed image data of the plurality of images; and
displaying the portions of the image data of the plurality of extracted images on the same screen.

10. The method according to claim 9, wherein, upon extracting the portions of the image data, a central region of the processed image data are extracted for each image.

11. The method according to claim 9, wherein, upon extracting the portions of the image data, a predetermined longitudinal divided region of the processed image data are extracted for each image.

12. The method according to claim 9, wherein, upon extracting the portions of the image data, a predetermined lateral divided region of the processed image data are extracted for each image.

13. The method according to claim 9 further comprising selecting a region of the image data to be extracted, and
wherein, upon extracting the portions of the image data, image data of the selected region is extracted.

14. The method according to claim 9, wherein the plurality of associated images include a series of successively sensed images.

15. The method according to claim 9, wherein the plurality of associated images include a series of images sensed successively while changing an exposure.

16. The method according to claim 9, wherein in extraction, an extraction region from each processed image data is determined in accordance with the number of associated images.

17. A computer-readable recording medium wherein the medium records a program for causing a computer to function as each of said units defined in claim 1.

18. A computer-readable recording medium wherein the medium records a program for causing a computer to execute the processing steps of the image display control method defined in claim 9.

19. An image sensing apparatus comprising the image display apparatus defined in claim 1.
